(19) United States
(12) Patent Application Publication
(10) Pub. No.: US 2026/0001485 A1
(43) Pub. Date: Jan. 1, 2026

(54) ELECTRO-OPTICAL VEHICLE MIRRORS

(71) Applicant: Adeia Guides Inc., San Jose, CA (US)

(72) Inventor: Zhiyun Li, Kenmore, WA (US)

(21) Appl. No.: 18/755,866

(22) Filed: Jun. 27, 2024

(51) Int. Cl. B60R 1/02; B60R 1/00; B60R 1/07; B60R 1/12; G02F 1/1335; G06V 40/18

(52) U.S. Cl. CPC B60R 1/025; B60R 1/006; B60R 1/07; G02F 1/133555; G06V 40/18; B60R 2001/1223; G02F 2203/09

(57) ABSTRACT

Systems and methods are provided for a vehicle mirror assembly. The vehicle mirror assembly comprises a housing comprising an opening and a cavity, a first mirror switchable between a reflective state and a transparent state, the first mirror disposed in the housing opening, and a second mirror disposed in the housing cavity behind the first mirror. The vehicle mirror assembly also comprises control circuitry coupled to the first mirror, wherein the control circuitry is configured to receive a first signal indicating a first vehicle state; transmit, based on the first signal, a second signal for switching the first mirror from the transparent state to the reflective state; receive a third signal indicating a second vehicle state; and transmit, based on the third signal, a fourth signal for switching the first mirror from the reflective state to the transparent state.

### BACKGROUND

The present disclosure is generally directed towards systems and methods for enabling electro-optical adjustable mirrors.

### SUMMARY

Vehicle side mirrors enable drivers to have an improved awareness of the environment around a vehicle and/or an improved awareness of a location of the vehicle with respect to other vehicles and/or objects around the vehicle. Typically, side mirrors comprise a housing and a mirror located in an opening of the housing. Side mirrors are usually mounted on vehicle doors, or a part of the chassis that is towards the front of a vehicle. In order for drivers of different heights to use the side mirrors comfortably, and to accommodate different seating preferences in a vehicle, the side mirrors are typically adjustable. Adjusting a side mirror typically comprises electronically transmitting instructions to a motor that is housed in the side mirror in order to adjust the mirror of the side mirror to different angles. In some examples, a direct mechanical link between a handle and the mirror of a side mirror may be utilized in order to adjust the mirror. Typically, a driver of a vehicle may adjust the side mirrors when reversing, for example, to park the vehicle. Over time, the motor driving the adjustment of the mirror may wear out or break, especially in low temperature conditions, such as frozen temperature conditions. Mechanical means for adjusting side mirrors may be slow and noisy. Additionally, a driver may, for example, either look at a curb view, or a side view, but not both views, which can lead to driver frustration and/or potential safety issues. In some vehicles, the side mirrors may automatically tilt to a pre-set position on the selection of a reverse gear; however, this still utilizes mechanical means to adjust the mirror, and the aforementioned problems are still present. In some examples, a physical mirror may be replaced with a camera and display; however, such an arrangement is prone to issues with a reduced dynamic range, the sensitivity of the camera in low light conditions and/or a safe failure mode when vehicle power is lost.

To help address these problems, systems and methods are provided herein that enable vehicle mirrors to be adjusted in an electro-optical manner.

In accordance with some aspects of the disclosure, a vehicle mirror assembly is provided. In an embodiment, the vehicle mirror assembly includes a housing comprising an opening and a cavity. A first mirror is disposed in the housing opening and is switchable between a reflective state and a transparent state, and a second mirror is disposed in the housing cavity behind the first mirror. Control circuitry is coupled to the first mirror, and the control circuitry is configured to receive a first signal indicating a first vehicle state; transmit, based on the first signal, a second signal for switching the first mirror from the transparent state to the reflective state; receive a third signal indicating a second vehicle state; and transmit, based on the third signal, a fourth signal for switching the first mirror from the reflective state to the transparent state.

In an example system, a car has two mirrors. A side mirror comprises a housing with a first mirror disposed in the opening of the housing, and a second mirror disposed in the cavity of the housing. The two mirrors may be arranged so that one of the first and the second mirrors is angled in a manner that is suitable for reversing, and the other mirror is angled in a manner that is suitable for normal driving. In this example, the first mirror is angled so that it is suitable for reversing. The first mirror is an electro-optical switchable mirror, which is switchable from a reflective state to a transparent state, and back again, in response to receiving an electrical signal. The switchable mirror may be a solid-state thin film device made from a liquid crystal material, which can be switched between pure reflection, half-reflection and total transparent states. The second mirror is a standard reflecting mirror. A control system of the car monitors whether a reverse gear is selected and, in response to the reverse gear being selected, transmits a signal to the first mirror to switch it to a reflective state. On the selection of a drive gear, the control system transmits a signal to the first mirror to switch it to a transparent state.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example mechanically operated side mirror.

FIG. 2 shows an example vehicle mirror assembly, in accordance with some embodiments of the disclosure;

FIG. 3 shows another example vehicle mirror assembly, in accordance with some embodiments of the disclosure;

FIG. 4 shows another example vehicle mirror assembly, in accordance with some embodiments of the disclosure;

FIG. 5 shows another example vehicle mirror assembly, in accordance with some embodiments of the disclosure;

FIG. 6 shows another example vehicle mirror assembly, in accordance with some embodiments of the disclosure;

FIG. 7 shows another example vehicle mirror assembly, in accordance with some embodiments of the disclosure;

FIG. 8 shows another example vehicle mirror assembly, in accordance with some embodiments of the disclosure;

FIG. 9 shows a block diagram representing components of a computing device and dataflow therebetween for enabling the control of an electro-optical mirror, in accordance with some embodiments of the disclosure; and

FIG. 10 shows a flowchart of illustrative steps for enabling the control of an electro-optical mirror, in accordance with some embodiments of the disclosure.

### DETAILED DESCRIPTION

Although vehicle side mirrors (also known as side-view mirrors, door mirrors and/or wing mirrors) are predominantly discussed herein, any suitable vehicle mirror, including a rear-view mirror, may be used. A mirror assembly is any assembly that is suitable for housing at least a first mirror and a second mirror. Typically, the mirror assembly comprises an opening and a cavity; however, a relatively thin mirror, such as those found on trucks, is also contemplated. The two mirrors may be arranged so that one of the first and the second mirrors is angled in a manner that is suitable for reversing, and the other mirror is angled in a manner that is suitable for normal driving. In other examples, where there are more than two mirrors, different angles are contemplated as well and are described in further detail below.

As used herein, a vehicle may be any vehicle including, for example, a car, a van, a truck, a bus, a boat and/or an airplane.

A switchable mirror is any mirror that is switchable from a reflective state to a transparent state (and/or a transparent state to a reflective state) in response to a signal. One example is an electro-optical switchable mirror comprising a solid-state thin film device made from a liquid crystal material, which can be switched between pure reflection, half-reflection and total transparent states. Another example is a transition-metal switchable mirror, which comprises thin film coatings on glass that can be converted from a transparent to a reflecting state and back again, by the application of an electric field (electrochromic switching). Other examples include thermochromic glass and polymer-dispersed liquid crystal devices.

A vehicle state is any state of a vehicle that may lead to a change in mirror orientation. One such state includes a state wherein a reverse gear of the vehicle is selected.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media card, register memory, processor cache, random access memory (RAM) and/or a solid-state drive.

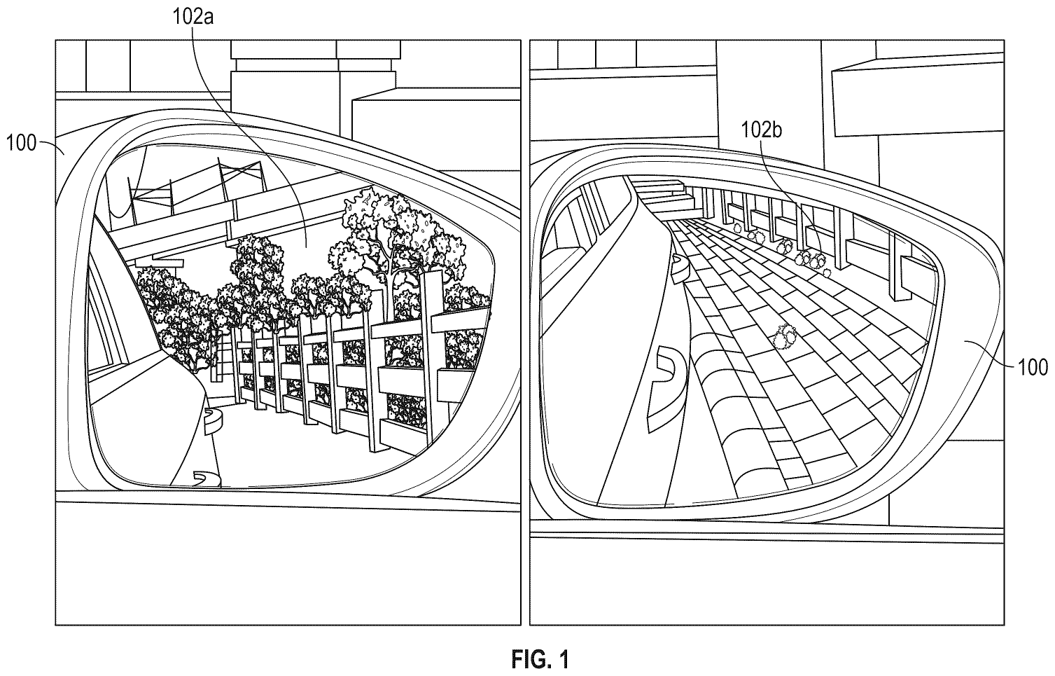

FIG. 1 shows an example mechanically operated side mirror. The mirror assembly 100 comprises a mirror located in an opening of the mirror assembly 100. The mirror is moveable from a first position 102a to a second position 102b and back again. The first position 102a may typically be used when driving a vehicle forward, and the second position 102b may typically be used when reversing the vehicle. The second position 102b enables a driver to, for example, view a curb to aid with positioning the vehicle when reversing. The mirror may either be manually controlled by a driver or, in some examples, the mirror may be automatically moved in response to a reverse gear being selected.

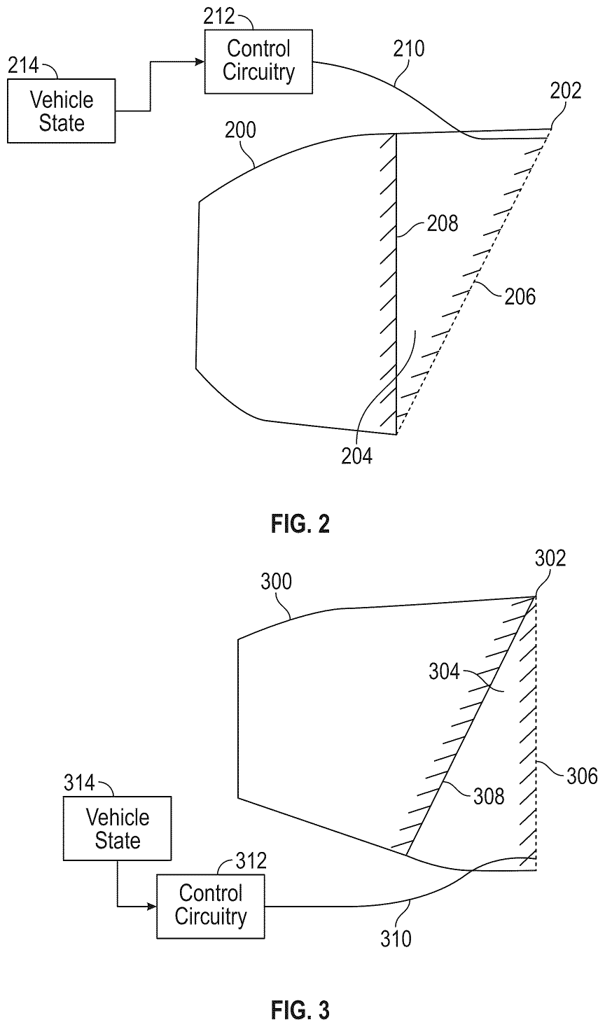

FIG. 2 shows a cross-sectional view of an example vehicle mirror assembly, in accordance with some embodiments of the disclosure. The mirror assembly 200 comprises an opening 202 and a cavity 204. A switchable mirror 206 is disposed within the opening 202, and a regular (non-switchable) mirror 208 is disposed within the cavity 204. In this example, the switchable mirror 206 is located at an angle, to aid with viewing the ground when reversing, and the regular mirror 208 is located relatively vertically to aid with viewing behind the vehicle when driving forward. A wire 210 connects the switchable mirror 206 to control circuitry 212. The control circuitry 212 transmits a signal via the wire 210 for switching the switchable mirror 206 between transparent and reflective states. The control circuitry 212 generates and transmits these signals in response to receiving vehicle state data from a vehicle state module 214. For example, the vehicle state module 214 indicates that a vehicle is in a reverse state or is in a drive state. In this example, if the vehicle is in a reverse state, a signal is transmitted from the control circuitry 212 to the switchable mirror 206 to make it reflective. Continuing this example, if the vehicle is in a drive state, a signal is transmitted from the control circuitry 212 to the switchable mirror 206 to make it transparent, so that the reflection from the regular mirror 208 is viewable through the opening 202. In some examples, it may be desirable to have a view of the ground and a view behind the vehicle at the same time. In this example, the switchable mirror 206 may be set to a half-reflection/half-transparent mode. As the use of a switchable mirror obviates the need for mechanical means to adjust a regular mirror when reversing, there is reduced motor wear, and the transition between two different viewing angles when reversing is quicker than with a mirror assembly comprising a motor for adjusting the mirror when reversing.

The orientation of the switchable mirror and/or regular mirrors may be adjusted independently via, for example, a motor. In some examples, the relative angle between the two mirrors may be fixed, and the orientation of both of the mirrors may be adjusted at the same time, for example, if an angle between the side-view and the curb-view is pre-determined. In some examples, the side mirror may be slightly concave. Once the mirrors are adjusted to the desired orientations, no further mechanical movements may be needed for switching between mirror orientations when driving forward and reversing.

FIG. 3 shows another cross-sectional view of an example vehicle mirror assembly, in accordance with some embodiments of the disclosure. The mirror assembly 300 comprises an opening 302 and a cavity 304. A switchable mirror 306 is disposed within the opening 302, and a regular (non-switchable) mirror 308 is disposed within the cavity 304. In this example, the switchable mirror 306 is located relatively vertically to aid with viewing behind the vehicle when driving forward, and the regular mirror 308 is located at an angle, to aid with viewing the ground when reversing. A wire 310 connects the switchable mirror 306 to control circuitry 312. The control circuitry 312 transmits a signal via the wire 310 for switching the switchable mirror 306 between transparent and reflective states. The control circuitry 312 generates and transmits these signals in response to receiving vehicle state data from a vehicle state module 314. For example, the vehicle state module 314 indicates that a vehicle is in a reverse state or is in a drive state. In this example, if the vehicle is in a reverse state, a signal is transmitted from the control circuitry 312 to the switchable mirror 306 to make it transparent, so that the reflection from the regular mirror 308 is viewable through the opening 302. Continuing this example, if the vehicle is in a drive state, a signal is transmitted from the control circuitry 312 to the switchable mirror 306 to make it reflective.

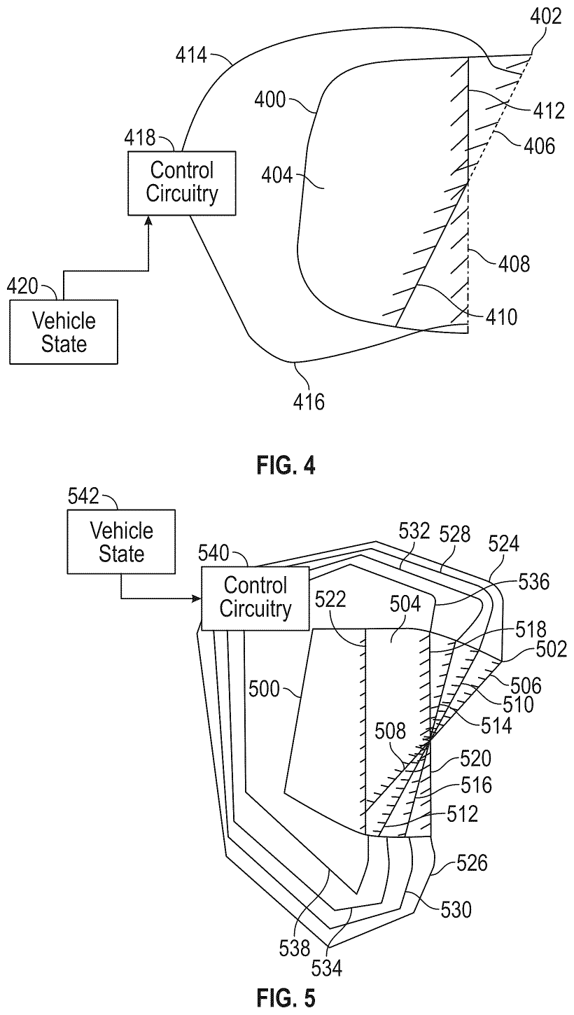

FIG. 4 shows another cross-sectional view of an example vehicle mirror assembly, in accordance with some embodiments of the disclosure. The mirror assembly 400 comprises an opening 402 and a cavity 404. A first switchable mirror 406 and a second switchable mirror 408 are disposed within the opening 402, and a first regular (non-switchable) mirror 410 and a second regular mirror 412 are disposed within the cavity 404. In this example, the first switchable mirror 406 and the first regular mirror 410 form a relatively continuous first surface that is located at an angle, to aid with viewing the ground when reversing. Continuing the example, the second switchable mirror 408 and the second regular mirror 412 form a relatively continuous second surface that is located relatively vertically to aid with viewing behind the vehicle when driving forward. A first wire 414 connects the first switchable mirror 406 to control circuitry 418, and a second wire 416 connects the second switchable mirror 408 to the control circuitry 418. The control circuitry 418 transmits a first signal via the first wire 414 for switching the first switchable mirror 406 between transparent and reflective states. The control circuitry 418 transmits a second signal via the second wire 416 for switching the second switchable mirror 408 between transparent and reflective states. The control circuitry 418 generates and transmits these signals in response to receiving vehicle state data from a vehicle state module 420. For example, the vehicle state module 420 indicates that a vehicle is in a reverse state or is in a drive state. In this example, if the vehicle is in a reverse state, a signal is transmitted from the control circuitry 418 to the first switchable mirror 406 to make it reflective and to the second switchable mirror 408 to make it transparent, so that the first surface is visible through the opening 402. Continuing this example, if the vehicle is in a drive state, a signal is transmitted from the control circuitry 418 to the first switchable mirror 406 to make it transparent and to the second switchable mirror 408 to make it reflective, so that the second surface is visible through the opening 402. As the first and second surfaces intersect, the mirror assembly may be relatively smaller when compared to a mirror assembly comprising a switchable mirror and a reflective mirror that do not intersect.

FIG. 5 shows another cross-sectional view of an example vehicle mirror assembly, in accordance with some embodiments of the disclosure. The mirror assembly 500 comprises an opening 502 and a cavity 504. A plurality of switchable mirrors, in this example, first to eighth switchable mirrors 506-520, are disposed within the opening 502, and a regular (non-switchable) mirror 522 is disposed within the cavity 522. In this example, the switchable mirrors 506-520 are arranged in pairs that form four relatively continuous surfaces that are located at different angles, to aid with viewing the ground when reversing. Continuing the example, the regular mirror 522 is located relatively vertically to aid with viewing behind the vehicle when driving forward. First to eighth wires 524-538 each connect a respective first to eighth switchable mirror 506-520 to control circuitry 540. The control circuitry 540 transmits first to eighth signals via respective first to eighth wires 524-538 for switching each respective switchable mirror 506-520 between transparent and reflective states. Typically a pair of mirrors that make up a surface will be set to a reflective state, and the other mirrors set to a transparent state. The control circuitry 540 generates and transmits these signals in response to receiving vehicle state data from a vehicle state module 542. For example, the vehicle state module 542 indicates that a vehicle is in a reverse state or is in a drive state. In this example, if the vehicle is in a reverse state, a signal is transmitted from the control circuitry 540 to the first and second switchable mirrors 506, 508 to make them reflective and to the third-eighth switchable mirrors 512, 516, 520 to make them transparent. If the driver selects a different viewing angle for reversing, for example, the third and fourth 510, 512 switchable mirrors may be switched to make them reflective, and the first mirror 506 and the seventh and eighth mirrors 516, 520 may be switched to make them transparent. Continuing this example, if the vehicle is in a drive state, a signal is transmitted from the control circuitry 540 to the first to eighth switchable mirrors 506-520 to make them transparent, so that the regular mirror 522 is visible through the opening 502. In this manner, the viewing angle of the mirrors may be changed when, for example, a vehicle is reversing, without the need for a mechanical component.

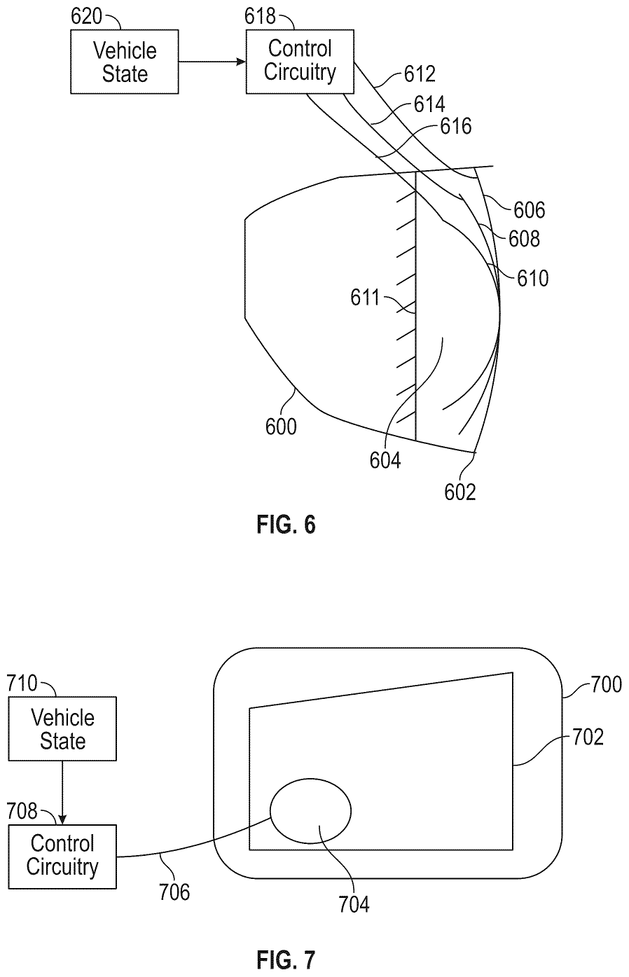

FIG. 6 shows another cross-sectional view of an example vehicle mirror assembly, in accordance with some embodiments of the disclosure. The mirror assembly 600 comprises an opening 602 and a cavity 604. A plurality of convex switchable mirrors, in this example, curved switchable mirrors 606-610 are disposed within the opening 602, and a regular (non-switchable) mirror 611 is disposed within the cavity 604. Wires 612-616 connect each of the switchable mirrors 606-610, to control circuitry 618. The control circuitry 618 transmits a signal via the wires 612-616 for switching the respective switchable mirrors between transparent and reflective states. The control circuitry 618 generates and transmits these signals in response to receiving vehicle state data from a vehicle state module 620 and/or input from a driver. In this example, the different curvatures of the convex mirrors provide different fields of view. For example, the first convex mirror 606 has a relatively small curvature and will provide a smaller field of view than the third convex mirror 610, which has a relatively large curvature and will provide a larger field of view. In response to a selection by a driver, the control circuitry will make a selected switchable mirror reflective and the other switchable mirrors transparent, so that a reflection with a desired field of view is visible through the opening 602. In some examples, a plurality of concave mirrors with different curvatures of radius may be utilized to provide different levels of zoom in a similar manner. In a further example, the plurality of mirrors may comprise a stack of convex and concave mirrors, each individually switchable, to provide different fields of view and/or zooms.

FIG. 7 shows a front view of an example vehicle mirror assembly, in accordance with some embodiments of the disclosure. The mirror assembly 700 comprises a regular (non-switchable) mirror 702 and a relatively small switchable convex mirror 704. A wire 706 connects the switchable convex mirror 704 to control circuitry 708. The control circuitry 708 transmits a signal via the wire 706 for switching the switchable convex mirror 704 between transparent and reflective states. The control circuitry 708 generates and transmits these signals in response to receiving vehicle state data from a vehicle state module 710 and/or input from a driver. In this example, the switchable convex mirror 704 provides a different field of view that may aid with reversing. For example, the vehicle state module 710 indicates that a vehicle is in a reverse state or is in a drive state. In this example, if the vehicle is in a reverse state, a signal is transmitted from the control circuitry 708 to the switchable convex mirror 704 to make it reflective, to aid with reversing by providing a larger field of view. Continuing this example, if the vehicle is in a drive state, a signal is transmitted from the control circuitry 708 to the switchable convex mirror 704 to make it transparent.

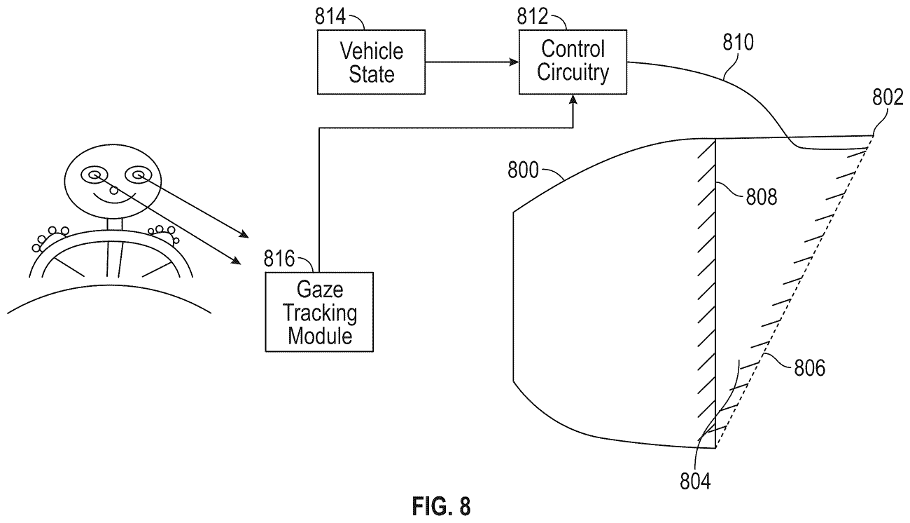

FIG. 8 shows another example vehicle mirror assembly, in accordance with some embodiments of the disclosure. The mirror assembly 800 comprises an opening 802 and a cavity 804. A switchable mirror 806 is disposed within the opening 802, and a regular (non-switchable) mirror 808 is disposed within the cavity 804. In this example, the switchable mirror 806 is located at an angle, to aid with viewing the ground when reversing, and the regular mirror 808 is located relatively vertically to aid with viewing behind the vehicle when driving forward. A wire 810 connects the switchable mirror 806 to control circuitry 812. The control circuitry 812 transmits a signal via the wire 810 for switching the switchable mirror 806 between transparent and reflective states. The control circuitry 812 generates and transmits these signals in response to receiving vehicle state data from a vehicle state module 814 and a gaze tracking module 816. For example, the vehicle state module 814 indicates that a vehicle is in a reverse state or is in a drive state, and the gaze tracking module receives an input indicating where a gaze of a driver is. The gaze of the driver may be, for example, captured by one or more cameras, and the output of the cameras may be processed by image tracking processing. In this example, if the vehicle is in a reverse state, a signal is transmitted from the control circuitry 812 to the switchable mirror 806 to make it reflective. The orientation of the switchable mirror 806 may also be changed in response to the direction of the gaze of the user. Continuing this example, if the vehicle is in a drive state, a signal is transmitted from the control circuitry 812 to the switchable mirror 806 to make it transparent, so that the reflection from the regular mirror 808 is viewable through the opening 802. The orientation of the regular mirror 808 may also be changed in response to the direction of the gaze of the user.

In another example, the switchable mirror 806 may be automatically controlled by the gaze of the user. For example, if the switchable mirror 806 is set to transparent, and if the driver wants to look downward at the curb, then the driver may naturally raise up a little from a vehicle seat while looking at the bottom edge of the mirror, so that the eye direction will tilt down. This eye movement and direction may be monitored via a vehicle sensor, such as a camera, to predict an intention of the user. Similarly, if the user intends to change a field of view of the mirror, as discussed in connection with FIG. 6 above, then their eyes may move towards or away from the mirror assembly 600, which may be used to select a convex mirror 606-610. In another example, if a user eye gaze is targeted at the switchable convex mirror 704 as discussed in connection with FIG. 7 above, then the switchable convex mirror 704 may be turned on and off accordingly.

Any combination of the mirrors of FIGS. 2-8 may be stacked. For example, the switchable convex mirror 704 of FIG. 7 may be combined with the convex mirrors 606-610 of FIG. 6, or the plurality of switchable mirrors 506-520 of FIG. 5. Likewise, the plurality of switchable mirrors 506-520 of FIG. 5 may comprise one or more convex mirrors, similar to those of FIG. 6.

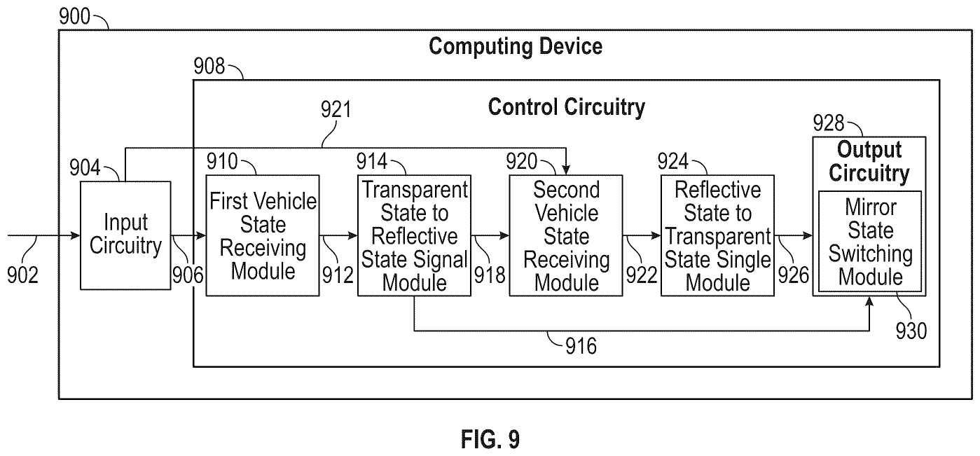

FIG. 9 shows a block diagram representing components of a computing device and dataflow therebetween for enabling the control of an electro-optical mirror, in accordance with some embodiments of the disclosure. Computing device 900 comprises input circuitry 904, control circuitry 908 and output circuitry 928. The computing device 900 may be, for example, a control unit for a mirror assembly 200, 300, 400, 500, 600, 700, 800. Control circuitry 908 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

A first input is received 902 by the input circuitry 904. The input circuitry 904 is configured to receive inputs related to a computing device. For example, this may be via a vehicle status module, user-provided input and/or input from a gaze tracking module. The input circuitry 904 transmits 906 the user input to the control circuitry 908.

The control circuitry 908 comprises a first vehicle state receiving module 910, a transparent state to reflective state signal module 914, a second vehicle state receiving module 920, a reflective state to transparent state signal module 924 and output circuitry 928 comprising a mirror state switching module 930. The input is transmitted 906 to the first vehicle state receiving module 910, where a first vehicle state is received. In response to receiving the first vehicle state, an indication of the first vehicle state is transmitted 912 to the transparent state to reflective state signal module 914. An indication to switch the mirror from the transparent state to the reflective state is transmitted 916 to the output circuitry 928, where the mirror state switching module 930 switches a switchable mirror from a transparent state to a reflective state. The transparent state to reflective state signal module 914 also transmits 918 an indication to the second vehicle state receiving module 920. The input circuitry also transmits 921 a second input to the second vehicle state receiving module 920. In response to receiving the second vehicle state, an indication of the second vehicle state is transmitted 922 to the reflective state to transparent state signal module 924. An indication to switch the mirror from the reflective state to the transparent state is transmitted 926 to the output circuitry 928, where the mirror state switching module 930 switches the switchable mirror from the reflective state to the transparent state.

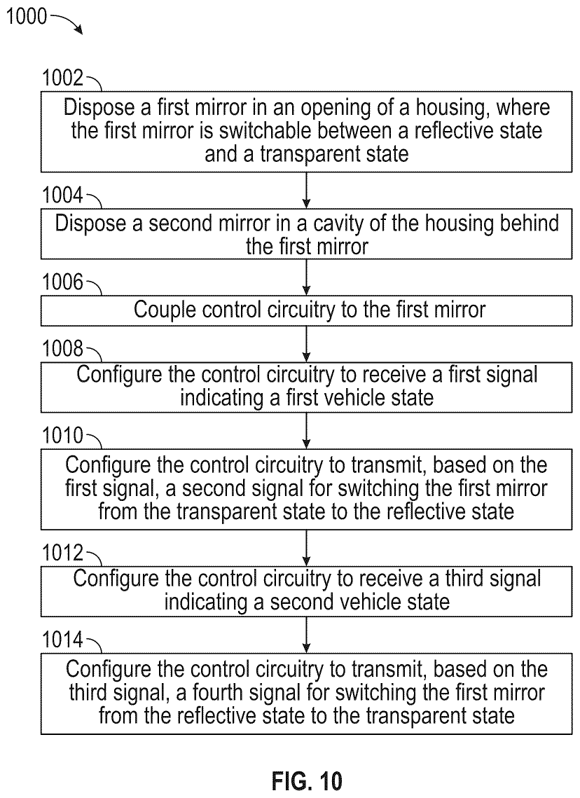

FIG. 10 shows a flowchart of illustrative steps for enabling the control of an electro-optical mirror, in accordance with some embodiments of the disclosure. Process 1000 may be implemented, in whole or in part, with any of the mirror assemblies mentioned herein. In addition, one or more actions of the process 1000 may be incorporated into or combined with one or more actions of any other processes or embodiments described herein.

At step 1002, a first mirror switchable between a reflective state and a transparent state is disposed in a housing opening. At step 1004, a second mirror is disposed in the housing cavity behind the first mirror. At step 1006, control circuitry is coupled to the first mirror. At step 1008, the control circuitry is configured to receive a first signal indicating a first vehicle state. At step 1010, the control circuitry is configured to transmit, based on the first signal, a second signal for switching the first mirror from the transparent state to the reflective state. At step 1012, the control circuitry is configured to receive a third signal indicating a second vehicle state, and at step 1014, the control circuitry is configured to transmit, based on the third signal, a fourth signal for switching the first mirror from the reflective state to the transparent state.

In some examples, the control circuitry 212, 312, 418, 540, 618, 708, 812 may receive one or more signals from a blind spot detection module. The blind spot detection module may receive input from one or more sensors, such as cameras, and may detect one or more hazards, such as vehicles, people and/or objects, in a vehicle blind spot and, in response, transmit a signal to the control circuitry 212, 312, 418, 540, 618, 708, 812 to switch one or more switchable mirrors from a transparent state to a reflective state, or from a reflective state to a transparent state, to indicate the hazard in the blind spot to the driver. Such a system may utilize an artificial intelligence algorithm and/or network to aid with detecting hazards in a vehicle blind spot.

In other examples, the control circuitry 212, 312, 418, 540, 618, 708, 812 may receive one or more signals that a left or right indicator is activated. In response to receiving a signal that an indicator is activated, the control circuitry 212, 312, 418, 540, 618, 708, 812 may switch one or more switchable mirrors from a transparent state to a reflective state, or from a reflective state to a transparent state, to aid with a turning maneuver. The control circuitry 212, 312, 418, 540, 618, 708, 812 may receive input from any other vehicle system including, for example, a vehicle lane departure system. On detecting that a vehicle is about to, or has, departed from a lane, a lane departure system module may transmit a signal to the control circuitry 212, 312, 418, 540, 618, 708, 812. In response to receiving the signal, the control circuitry 212, 312, 418, 540, 618, 708, 812 may switch one or more switchable mirrors from a transparent state to a reflective state, or from a reflective state to a transparent state, to aid with correcting the lane departure.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A vehicle mirror assembly, comprising:
a housing comprising an opening and a cavity;
a first mirror switchable between a reflective state and a transparent state, the first mirror disposed in the housing opening;
a second mirror disposed in the housing cavity behind the first mirror; and
control circuitry coupled to the first mirror, wherein the control circuitry is configured to:
receive a first signal indicating a first vehicle state;
transmit, based on the first signal, a second signal for switching the first mirror from the transparent state to the reflective state;
receive a third signal indicating a second vehicle state; and
transmit, based on the third signal, a fourth signal for switching the first mirror from the reflective state to the transparent state.

2. The vehicle mirror assembly of claim 1, wherein:
the first vehicle state indicates a first selection of a reverse gear at a vehicle; and
the second vehicle state indicates a second selection of a forward gear at the vehicle.

3. The vehicle mirror assembly of claim 1, wherein:
the first mirror comprises a first section and a second section, wherein the first section and the second section are each independently switchable between the reflective state and the transparent state; and
the control circuitry configured to transmit the second signal for switching the first mirror from the transparent state to the reflective state is further configured to transmit the second signal for switching the first section of the first mirror to the reflective state.

4. The vehicle mirror assembly of claim 1, wherein:
the reflective state is a first reflective state and the transparent state is a first transparent state;
the vehicle mirror assembly further comprises:
a third mirror disposed proximate to the first mirror such that the first mirror and the third mirror comprise a first surface;
a fourth mirror switchable between a second reflective state and a second transparent state disposed proximate to the second mirror such that the second mirror and the fourth mirror comprise a second surface, wherein the first and third mirrors and the second and fourth mirrors are arranged such that the first surface and the second surface intersect; and
the control circuitry is further configured to:
transmit, based on the first signal, a fifth signal for switching the fourth mirror from the second transparent state to the second reflective state; and
transmit, based on the third signal, a sixth signal for switching the fourth mirror from the second reflective state to the second transparent state.

5. The vehicle mirror assembly of claim 1, wherein the vehicle mirror assembly further comprises:
a plurality of mirrors, each mirror of the plurality of mirrors switchable between respective reflective and transparent states, wherein:
each mirror of the plurality of mirrors is disposed in the housing at a fixed angle relative to the other mirrors of the plurality of mirrors;
the plurality of mirrors are arranged in pairs, with each pair of mirrors forming a respective surface such that a plurality of surfaces are formed; and
each surface of the plurality of surfaces intersects with each other surface at a common point.

6. The vehicle mirror assembly of claim 1, wherein:
the first mirror is curved mirror, and the first mirror is the first mirror of a plurality of curved switchable mirrors, each mirror of the plurality of curved switchable mirrors having a different radius of curvature; and
the plurality of curved switchable mirrors are arranged in the housing such that each mirror of the plurality of curved switchable mirrors provides a different level of zoom when it is respectively switched on.

7. The vehicle mirror assembly of claim 6, wherein the control circuitry is further configured to:
receive a fifth signal indicating a gaze direction of a driver of a vehicle;
determine that the gaze direction is towards the plurality of curved switchable mirrors for longer than a threshold amount of time; and
generate a sixth signal for switching a mirror of the plurality of curved switchable mirrors from a transparent state to a reflective state, such that a zoomed-in reflection is provided, based on the determination that the gaze direction is towards the plurality of curved switchable mirrors for longer than the threshold amount of time.

8. The vehicle mirror assembly of claim 1, wherein the first mirror is a convex mirror having a smaller surface area than the second mirror.

9. The vehicle mirror assembly of claim 8, wherein:
the first mirror is a movable mirror;
the control circuitry is further configured to:
receive a fifth signal indicating a gaze direction of a driver of a vehicle;
determine that the gaze direction is towards the first mirror; and
generate a sixth signal for switching the first mirror from a transparent state to a reflective state based on the determination that the gaze direction is towards the first mirror.

10. The vehicle mirror assembly of claim 1, wherein:
the first mirror is a movable mirror;
the control circuitry is further configured to:
receive a fifth signal indicating a gaze direction of a driver of a vehicle; and
generate a sixth signal for moving the first mirror in a direction based on the received fifth signal indicating the gaze direction of the driver of the vehicle.

11. The vehicle mirror assembly of claim 1, wherein:
the first mirror is switchable to a plurality of different semi-transparent states between the reflective state and the transparent state; and
the control circuitry is further configured to:
receive a fifth signal indicating a position of a steering wheel of a vehicle;
transmit, based on the fifth signal, a sixth signal for switching the first mirror to a semi-transparent state of the different semi-transparent states.

12. A method comprising:
disposing a first mirror in an opening of a housing, wherein the first mirror is switchable between a reflective state and a transparent state;
disposing a second mirror in a cavity of the housing behind the first mirror;
coupling control circuity to the first mirror; and
configuring the control circuitry to:
receive a first signal indicating a first vehicle state;
transmit, based on the first signal, a second signal for switching the first mirror from the transparent state to the reflective state;
receive a third signal indicating a second vehicle state; and
transmit, based on the third signal, a fourth signal for switching the first mirror from the reflective state to the transparent state.

13. The method of claim 12, wherein:
the first vehicle state indicates a first selection of a reverse gear at a vehicle; and
the second vehicle state indicates a second selection of a forward gear at the vehicle.

14. The method of claim 12, wherein:
the first mirror comprises a first section and a second section, wherein the first section and the second section are each independently switchable between the reflective state and the transparent state; and
configuring the control circuitry to transmit the second signal for switching the first mirror from the transparent state to the reflective state further comprises configuring the control circuitry to transmit the second signal for switching the first section of the first mirror to the reflective state.

15. The method of claim 12, wherein the reflective state is a first reflective state and the transparent state is a first transparent state, and the method further comprises:
disposing a third mirror disposed proximate to the first mirror such that the first mirror and the third mirror comprise a first surface;
disposing a fourth mirror switchable between a second reflective state and a second transparent state proximate to the second mirror such that the second mirror and the fourth mirror comprise a second surface, wherein the first and third mirrors and the second and fourth mirrors are arranged such that the first surface and the second surface intersect; and
configuring the control circuitry further comprises configuring the control circuitry to:
transmit, based on the first signal, a fifth signal for switching the fourth mirror from the second transparent state to the second reflective state; and
transmit, based on the third signal, a sixth signal for switching the fourth mirror from the second reflective state to the second transparent state.

16. The method of claim 12, wherein the method further comprises:
disposing each mirror of a plurality of mirrors in the housing at a fixed angle relative to the other mirrors of the plurality of mirrors, wherein each mirror of the plurality of mirrors is switchable between respective reflective and transparent states;
arranging the plurality of mirrors in pairs, with each pair of mirrors forming a respective surface such that a plurality of surfaces are formed and each surface of the plurality of surfaces intersects with each other surface at a common point.

17. The method of claim 12, wherein the first mirror is curved mirror, and the first mirror is the first mirror of a plurality of curved switchable mirrors, each mirror of the plurality of curved switchable mirrors having a different radius of curvature, the method further comprising arranging the plurality of curved switchable mirrors in the housing such that each mirror of the plurality of curved switchable mirrors provides a different level of zoom when it is respectively switched on.

18. The method of claim 17, wherein configuring the control circuitry further comprises configuring the control circuitry to:
receive a fifth signal indicating a gaze direction of a driver of a vehicle;
determine that the gaze direction is towards the plurality of curved switchable mirrors for longer than a threshold amount of time; and
generate a sixth signal for switching a mirror of the plurality of curved switchable mirrors from a transparent state to a reflective state, such that a zoomed-in reflection is provided, based on the determination that the gaze direction is towards the plurality of curved switchable mirrors for longer than the threshold amount of time.

19. The method of claim 1, wherein the first mirror is a convex mirror having a smaller surface area than the second mirror.

20. The method of claim 19, wherein the first mirror is a movable mirror, and configuring the control circuitry further comprises configuring the control circuitry to:
receive a fifth signal indicating a gaze direction of a driver of a vehicle;
determine that the gaze direction is towards the first mirror; and
generate a sixth signal for switching the first mirror from a transparent state to a reflective state based on the determination that the gaze direction is towards the first mirror.

21-33. (canceled)
